(19) United States
(12) Patent Application Publication
(10) Pub. No.: US 2026/0244991 A1
(43) Pub. Date: Aug. 20, 2026

(54) TIME-CONTINUOUS ANNOTATION PROCESSING SYSTEM AND METHODS FOR USE THEREWITH

(71) Applicant: Game AI Malta Limited, Ta' Xbiex (MT)

(72) Inventors: Georgios N. Yannakakis, Sliema (MT); David Melhart, Odense (DK)

(73) Assignee: Game AI Malta Limited, Ta' Xbiex (MT)

(21) Appl. No.: 19/530,854

(22) Filed: Feb. 5, 2026

Related U.S. Application Data
(60) Provisional application No. 63/758,689, filed on Feb. 14, 2025.

(51) Int. Cl. G06N 20/00

(52) U.S. Cl. CPC G06N 20/00

(57) ABSTRACT

A time-continuous annotation processing system operates by: sending a segment of time-continuous audiovisual (A/V) data to a first plurality of client devices; receiving subjective time-continuous annotation data corresponding to the segment of time-continuous A/V data, the subjective time-continuous annotation data indicating time-continuous annotated values of a subjective parameter varying over a time period of the segment of time-continuous A/V data; determining, via a subjective gold standard analysis tool, when there is a single ordinal agreement between the subjective time-continuous annotation data received from the first plurality of client devices, and in response: generating, via the subjective gold standard analysis tool, a first ordinal time-continuous gold standard annotation based on the ordinal agreement between the subjective time-continuous annotation data received from the first plurality of client devices; and constructing, via an A/V training data set post processing tool, an annotated time-continuous A/V training dataset to include the first ordinal time-continuous gold standard annotation and the segment of time-continuous A/V data; determining, via the subjective gold standard analysis tool, when there are a plurality of differing ordinal agreements of the subjective time-continuous annotation data received from the first plurality of client devices, and in response: generating, via the subjective gold standard analysis tool, a first plurality of differing ordinal time-continuous gold standard annotations based on the subjective time-continuous annotation data received from the first plurality of client devices; and constructing, via the A/V training data set post processing tool, the annotated time-continuous A/V training dataset to include the first plurality of differing ordinal time-continuous gold standard annotations and the segment of time-continuous A/V data; and training, via the annotated time-continuous A/V training dataset, a machine learning function that generates subjective time-continuous output data responsive to time-continuous A/V input data.

### CROSS-REFERENCE TO RELATED APPLICATIONS

The present U.S. Utility Patent Application claims priority pursuant to 35 U.S.C. § 119(e) to U.S. Provisional Application No. 63/758,689, entitled “TIME-CONTINUOUS ANNOTATION PROCESSING SYSTEM AND METHODS FOR USE THEREWITH”, filed Feb. 14, 2025, which is hereby incorporated herein by reference in its entirety and made part of the present U.S. Utility Patent Application for all purposes.

### STATEMENT REGARDING FEDERALLY SPONSORED RESEARCH OR DEVELOPMENT

Not Applicable.

### INCORPORATION-BY-REFERENCE OF MATERIAL SUBMITTED ON A COMPACT DISC

Not Applicable.

### BACKGROUND OF THE INVENTION

### Technical Field of the Invention

The disclosed subject matter relates to computer systems and devices for annotating time-continuous audiovisual data and generating/validating accurate ordinal training data sets used by machine learning engines that generate time-continuous ordinal output metrics.

### BRIEF DESCRIPTION OF THE SEVERAL VIEWS OF THE DRAWING(S)

FIG. 1A is a schematic block diagram of an example of a time-continuous annotation processing system that generates annotated time-continuous A/V training data datasets;

FIG. 1B is a schematic block diagram of an example machine learning engine;

FIG. 1C is a schematic block diagram of an example screen display;

FIG. 1D is a graphical example of subjective time-continuous annotation data;

FIG. 1E is a graphical example of subjective time-continuous annotation data;

FIG. 1F is a graphical example of subjective time-continuous annotation data;

FIG. 1G is a schematic block diagram of an example screen display;

FIG. 1H is a graphical example of subjective time-continuous annotation data;

FIG. 1I is a graphical example of subjective time-continuous annotation data;

FIG. 1J presents a flowchart representation of an example method;

FIGS. 2A through 2E are schematic block diagrams of embodiments of computing entities that are part of an improved computer technology;

FIGS. 2F through 2L are schematic block diagrams of embodiments of computing devices that form at least a portion of a computing entity;

FIG. 2M is a schematic block diagram of an embodiment of a database;

### DETAILED DESCRIPTION OF THE INVENTION

Machine learning engines provide powerful tools for advancing the capabilities of data processing. The accuracy of these processing systems is largely dependent on the scope and accuracy of the training datasets used to train them. This process is complicated however when machine learning engines operate on time-continuous data inputs (e.g., audiovisual data) and yield time-continuous data outputs and furthermore when such engines are trained on datasets that are of a subject nature and therefore lack an objective ground truth. The various systems and methods disclosed herein improve the field of data processing based on systems/techniques that generate time-continuous training datasets having valid and accurate annotations of data with subjective indices such as engagement, interest, motivation, experience, tension, excitement, readiness, satisfaction, bias, and/or other subjective characterization, quantity, value and/or index that is non-objective, may have an ambiguous meaning and/or cannot be objectively defined. The various systems and methods disclosed are capable of limiting the amount of data required from users for approximating subjective ground truths while guaranteeing high degrees of data and model reliability.

A time-continuous annotation processing system 5 is presented that includes a memory that stores QA task data 10, and annotator assessment data 12. The time-continuous annotation processing system 5 further includes an audiovisual (A/V) segmentation and highlighting tool 14, an ordinal annotation pre-processing tool 16, an annotation complexity analysis tool 18, an annotation fatigue detection tool 20, a subjective gold standard analysis tool 22 and an A/V training dataset post processing tool 24. In operation, the time-continuous annotation processing system 30 receives time-continuous A/V data 2 and generates segments of time-continuous A/V data 6-1 . . . 6-n that are sent to client devices 25-1 . . . 25-n for annotation/labelling. In response, subjective time-continuous annotation data 4-1 . . . 4-n is generated by the client devices 25-1 . . . 25-n. This subjective time-continuous annotation data 4-1 . . . 4-n is collected, processed and analyzed in order to produce accurate and reliable time-continuous A/V training dataset(s) 8 for use in training a machine learning engine that processes time-continuous A/V input data and generating ordinal time-continuous output data that reflects one or more subjective indices.

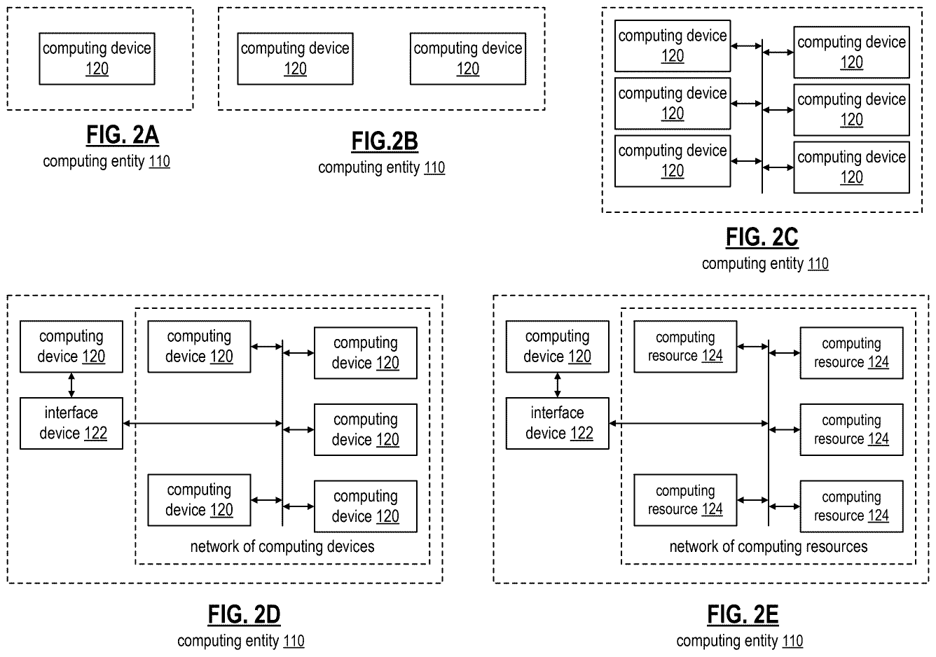

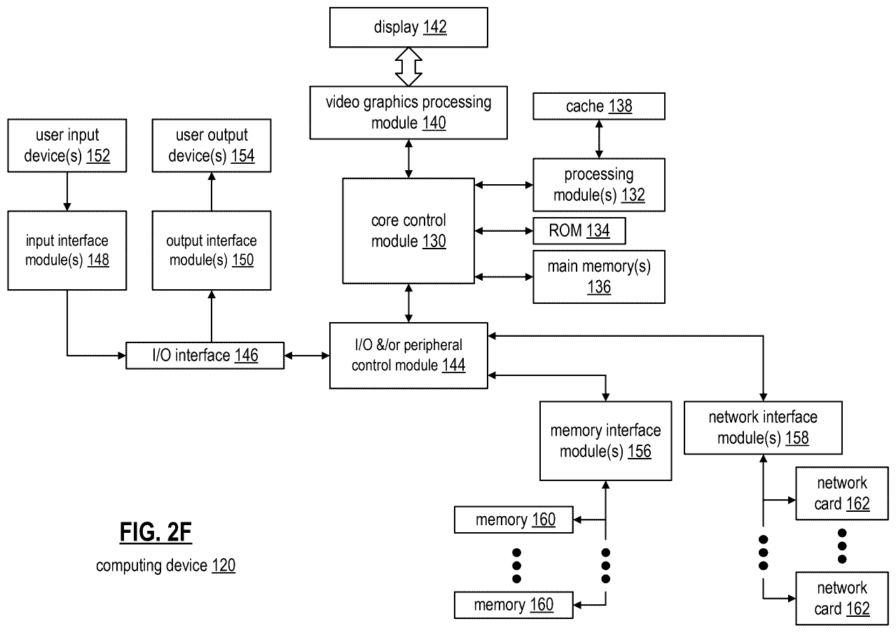

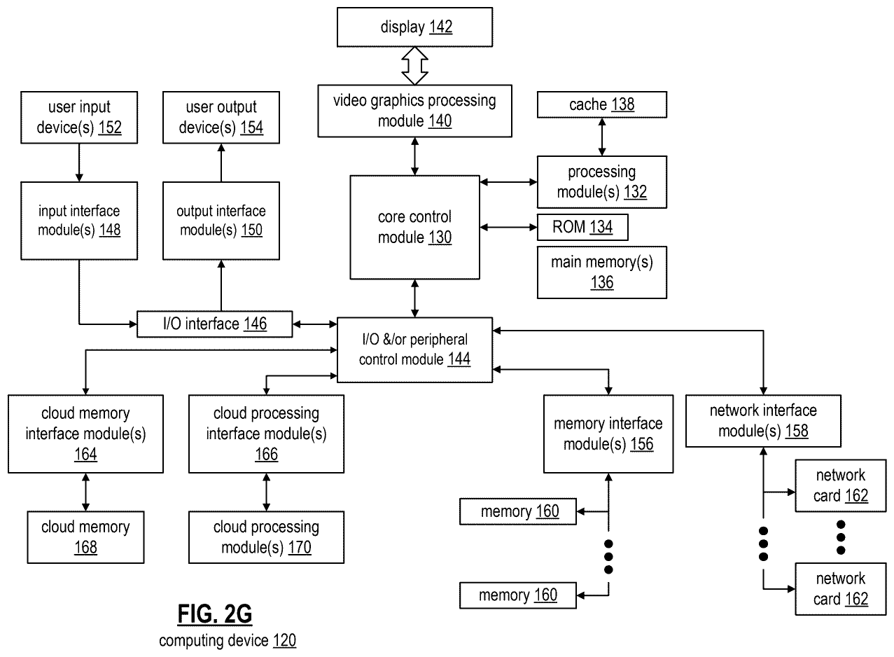

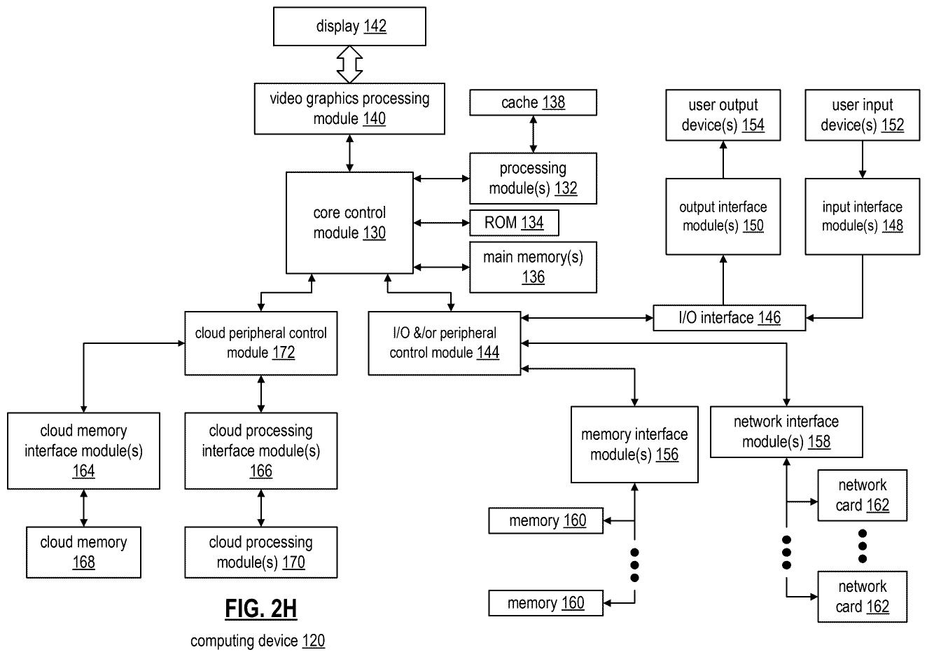

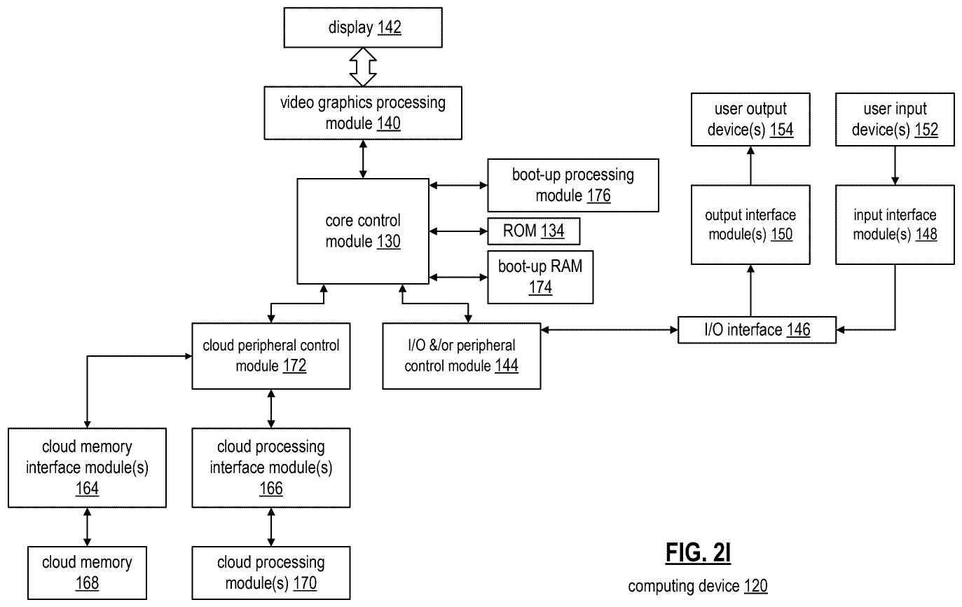

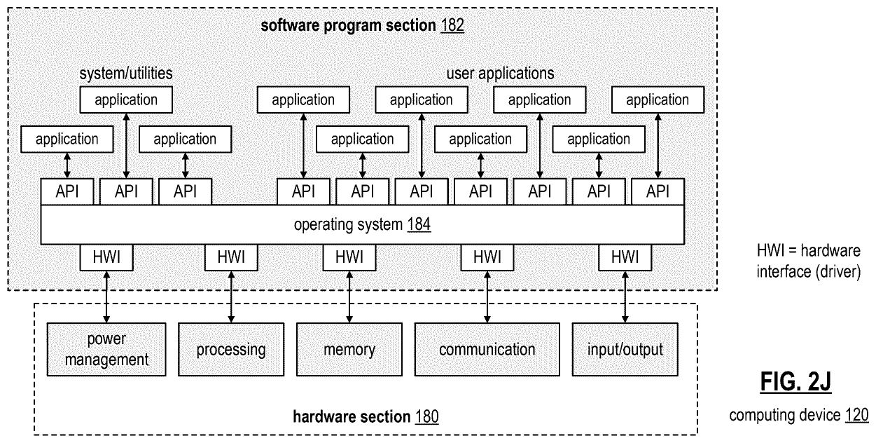

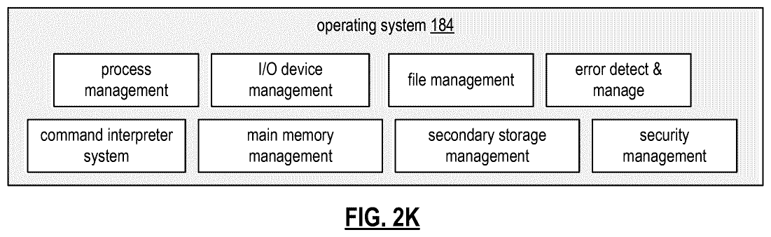

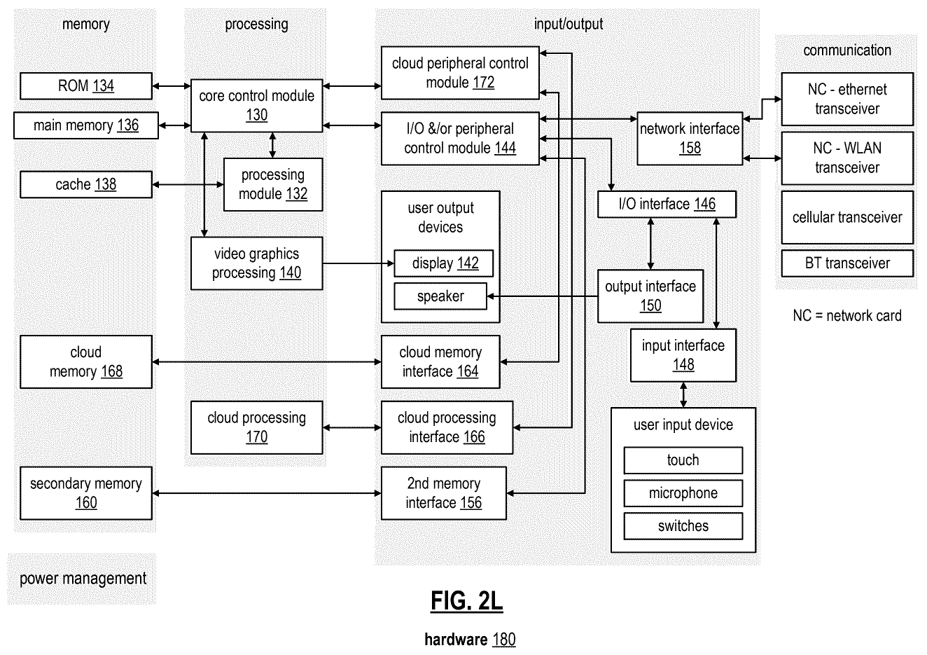

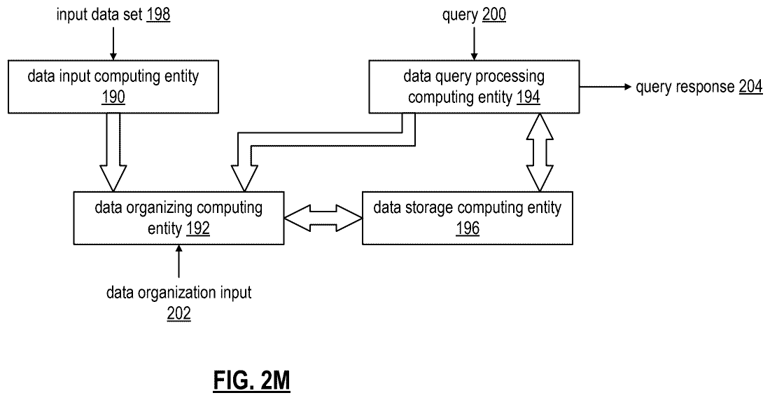

In various examples, the client device 25-1 . . . 25-n can each be implemented via a computing entity 110, such as a smartphone, tablet, laptop or other personal computing system associated with a user either alone or in association with a cloud computing environment—that will be described in greater detail in conjunction with FIG. 2A-2M that follow. The time-continuous annotation processing system 5 can also be implemented via one or more computing entities 110. In particular, while shown as a single system, the data storage and separate tools can be implemented via differing computing entities or in other combinations two or more computing entities, whether alone, in combination, or in association with a cloud computing environment.

In various examples, the systems and methods disclosed herein generate training datasets with annotation labels that are temporal, time-continuous and are appropriate for any type of subjective index. These labeling techniques provide rapid and reliable annotation of naturally moving frames of time-continuous audio and/or video and not merely a series of frames that are not necessarily sequential. These techniques cross-verify the reliability of provided labels as the labels themselves are of subjective nature. Furthermore, the techniques described herein can ignore the magnitude of any scores provided and instead process data as ordinal phenomena over time. In this fashion, relational measures such as trends, ranks, non-parametric statistics and/or other ordinal analysis over time can be used to calculate corresponding complexity, confidence, agreement, disagreement, uncertainty and/or other parameters based on the annotation data. Finally, the methods disclosed may identify and highlight aspects of an audiovisual stimulus that require annotation labels limiting the required amount of data to minimum.

Sometimes opinions converge and a single underlying gold-standard annotation (e.g., a temporal pattern which replaces the ground truth as an ordinal agreement regarding the subjective parameter) is easier to identify; sometimes opinions are divergent. In the latter case, the systems and methods described herein can either establish multiple (and differing) gold-standard annotations about a phenomenon (e.g., temporal patterns of interest or tension) or can automatically compute a complexity score for the labeling task which can be used, for example, to identify a region in the input that needs further analysis by further annotators. Furthermore, temporal statistical techniques (that can include non-parametric statistics) that rely on ordinal/relative changes can be used to measure similarity (and consequently non-similarity) of annotation traces over time. These techniques can also be used in generating gold-standard annotations that indicate an approximate consensus and a corresponding confidence thereof. Such temporal/ordinal techniques can also be used to capture the fatigue of annotators or habituation effects over a sequence of annotation tasks.

In various examples, the systems and methods disclosed herein assess (and hence, ensure) annotation reliability through objectively defined tasks and/or through subjectively-defined tasks wherein there is no expert or ground truth-only opinions. In various examples, the objectively-defined quality assurance (QA) tasks, and/or a series of subjectively defined tasks are weighted by labeling difficulty/complexity as described above. Annotator reliability can then be represented by factors such as (e.g., QA performance, degree of consensus with others, labeling performance and complexity of labeling, labeling time, labeling order and number of labeling tasks completed,) that can be computed through simple statistical measures but also via machine learned models once annotators provide sufficient interaction/labeling data. Such reliability can be used to qualify annotators for labelling tasks based on annotation complexity and/or based on QA performance that compares favorably to a QA threshold (e.g., having a measured error rate below a threshold or having a positive QA performance that exceeds a threshold).

In various examples, task complexity can be measured as functions of ordinal agreement over time across a number of annotators. High degrees of disagreement among annotators can either point to high degrees of ambiguity (task complexity) or alternatively, to the existence of multiple differing gold-standard annotation of a particular annotation label over a labeling task. Temporal clustering methods and/or other temporal statistical techniques that analyze ordinal data can be used to determine degrees of consensus, agreement and/or disagreement, the presence of a single gold-standard annotation (i.e., a global standard), multiple gold-standard annotations (e.g., multi-standard) and/or recalibrate the complexity score based on the number and type of clusters. In other examples, complexity can be calculated based on a degree of ordinal agreement/disagreement or other measure of distance over time under the assumption of a global standard that characterizes a labeling task.

Highlighting and/or segmentation of the A/V data to be annotated can be determined based on ambiguity/complexity. In various examples, certain time windows of the A/V content to be annotated can be highlighted and then be presented to an annotator. These highlighted areas (e.g., segments and/or portions thereof) can be determined through levels of ordinal ambiguity that can be calculated over existing annotation traces. Such traces can be provided by human annotators or instead be autonomously generated from video understanding and processing methods including various vision encoders or vision based media models (e.g. video language models). The systems and methods can determine the need for more human annotations for better estimating the annotation standard(s) of the label and the complexity of the task. Furthermore, the systems and methods tool can also be able to predict how many more samples of annotated traces are needed for maximizing the reliability of data, for maximizing the accuracy and confidence in the gold standard annotation(s) and for lowering the uncertainty of the predictive models. An estimate of the amount of training data required in relation to model accuracy can also be determined. When annotation data is collected for training or fine-tuning autonomous annotation methods, the tools can specify the regions and the amount of annotation data required per region to train highly accurate models for specific labels (such as tension, stress or engagement).

Consider the following additional examples that can be used in addition of in conjunction with any of the foregoing and where a time-continuous annotation processing system is implemented via one or more computing entities 110 that include a network interface configured to communicate via a communications network; a memory configured to store instructions; and at least one processor configured to execute the instructions, which when executed, cause the at least one processor to perform operations that include:
sending, via the network interface, a segment of time-continuous audiovisual (A/V) data to a first plurality of client devices;
receiving, via the network interface and from the first plurality of client devices, subjective time-continuous annotation data corresponding to the segment of time-continuous A/V data, the subjective time-continuous annotation data indicating time-continuous annotated values of a subjective parameter varying over a time period of the segment of time-continuous A/V data;
determining, via a subjective gold standard analysis tool, when there is a single ordinal agreement between the subjective time-continuous annotation data received from the first plurality of client devices; and in response:
   generating, via the subjective gold standard analysis tool, a first ordinal time-continuous gold standard annotation based on the single ordinal agreement between the subjective time-continuous annotation data received from the first plurality of client devices; and
   constructing, via an A/V training data set post processing tool, an annotated time-continuous A/V training dataset to include the first ordinal time-continuous gold standard annotation and the segment of time-continuous A/V data, wherein the annotated time-continuous A/V training dataset is stored in the memory with a linkage between the first ordinal time-continuous gold standard annotation and the segment of time-continuous A/V data;
determining, via the subjective gold standard analysis tool, when there are a plurality of differing ordinal agreements of the subjective time-continuous annotation data received from the first plurality of client devices, and in response:
   generating, via the subjective gold standard analysis tool, a first plurality of differing ordinal time-continuous gold standard annotations based on the subjective time-continuous annotation data received from the first plurality of client devices; and
   constructing, via the A/V training data set post processing tool, the annotated time-continuous A/V training dataset to include the first plurality of differing ordinal time-continuous gold standard annotations and the segment of time-continuous A/V data wherein the annotated time-continuous A/V training dataset is stored in the memory with a linkage between the first plurality of differing ordinal time-continuous gold standard annotations and the segment of time-continuous A/V data; and
wherein the annotated time-continuous A/V training dataset is configured for training a machine learning engine that generates subjective time-continuous output data responsive to time-continuous A/V input data.

In addition or the alternative to any of the foregoing, the operations further include:
determining, via a subjective gold standard analysis tool, when there is an ordinal disagreement between the subjective time-continuous annotation data received from the first plurality of client devices for at least a portion of the segment of time-continuous A/V data;
sending, via the network interface, the at least a portion of the segment of time-continuous A/V data to a second plurality of client devices;
receiving, via the network interface and from the second plurality of client devices, subjective time-continuous annotation data corresponding to the at least a portion of the segment of time-continuous A/V data; and
resolving the ordinal disagreement based on the subjective time-continuous annotation data corresponding to the at least a portion of the segment of time-continuous A/V data received from the second plurality of client devices.

In addition or the alternative to any of the foregoing, resolving the ordinal disagreement includes generating, via the subjective gold standard analysis tool, a second plurality of differing ordinal time-continuous gold standard annotations, and wherein the operations further include constructing, via the A/V training data set post processing tool, the annotated time-continuous A/V training dataset to include the second plurality of differing ordinal time-continuous gold standard annotations and the segment of time-continuous A/V data.

In addition or the alternative to any of the foregoing, resolving the ordinal disagreement includes generating, via the subjective gold standard analysis tool, a second ordinal time-continuous gold standard annotation, and wherein the operations further include constructing, via the A/V training data set post processing tool, the annotated time-continuous A/V training dataset to include the second ordinal time-continuous gold standard annotations and the segment of time-continuous A/V data.

In addition or the alternative to any of the foregoing, a number of the second plurality of client devices is determined based on an amount of the disagreement between the subjective time-continuous annotation data received from the first plurality of client devices.

In addition or the alternative to any of the foregoing, the operations further include determining, via an annotation complexity analysis tool, an annotation complexity based on an amount of the disagreement between the subjective time-continuous annotation data received from the first plurality of client devices;

In addition or the alternative to any of the foregoing, the operations further include:
generating an indication, via a segmentation and highlighting tool, of the at least a portion of the segment of time-continuous A/V data; and
sending, via the network interface, the indication in conjunction with the at least a portion of the segment of time-continuous A/V data to the second plurality of client devices.

In addition or the alternative to any of the foregoing, the disagreement between the subjective time-continuous annotation data received from the first plurality of client devices is determined based on a clustering function.

In addition or the alternative to any of the foregoing, the operations further include:
receiving annotator identifiers associated with each of the first plurality of client devices;
determining, via an annotation fatigue detection tool, an annotator fatigue condition associated with one of the first plurality of client devices; and
de-weighting, via the subjective gold standard analysis tool, the subjective time-continuous annotation data received from the one of the first plurality of client devices.

In addition or the alternative to any of the foregoing, the annotator fatigue condition is detected based on an amount of disagreement between the subjective time-continuous annotation data received from the one of the first plurality of client devices and others of the first plurality of client devices.

In addition or the alternative to any of the foregoing, the annotator fatigue condition is detected based on an annotation complexity.

In addition or the alternative to any of the foregoing, the annotator fatigue condition is detected based on a continuous annotation duration associated with the one of the first plurality of client devices.

In addition or the alternative to any of the foregoing, the annotator fatigue condition is detected based on an annotator identifier associated with the one of the first plurality of client devices.

In addition or the alternative to any of the foregoing, the segment of time-continuous A/V data is generated, via an A/V segmentation and highlighting tool, by segmenting time-continuous A/V data.

In addition or the alternative to any of the foregoing, the subjective time-continuous annotation data received from the first plurality of client devices is ordinal preprocessed, via an ordinal annotation preprocessing tool, prior to input to the subjective gold standard analysis tool.

In addition or the alternative to any of the foregoing, the memory further stores a plurality of annotator assessment data and wherein the first plurality of client devices are selected based on the annotator assessment data.

In addition or the alternative to any of the foregoing, the memory further stores a plurality of quality assessment (QA) task data, wherein the plurality of annotator assessment data is determined based on QA annotation data generated by a second plurality of client devices responsive to the QA task data, and wherein the first plurality of client devices is a non-null subset of the second plurality of client devices.

In addition or the alternative to any of the foregoing, the first plurality of client devices are selected based on at least one QA threshold.

In addition or the alternative to any of the foregoing, the subjective gold standard analysis tool determines when there is the single ordinal agreement based on a clustering function identifying a single cluster from the subjective time-continuous annotation data.

In addition or the alternative to any of the foregoing, the subjective gold standard analysis tool determines when there are a plurality of differing ordinal agreements based on the clustering function identifying a plurality of differing clusters from the subjective time-continuous annotation data.

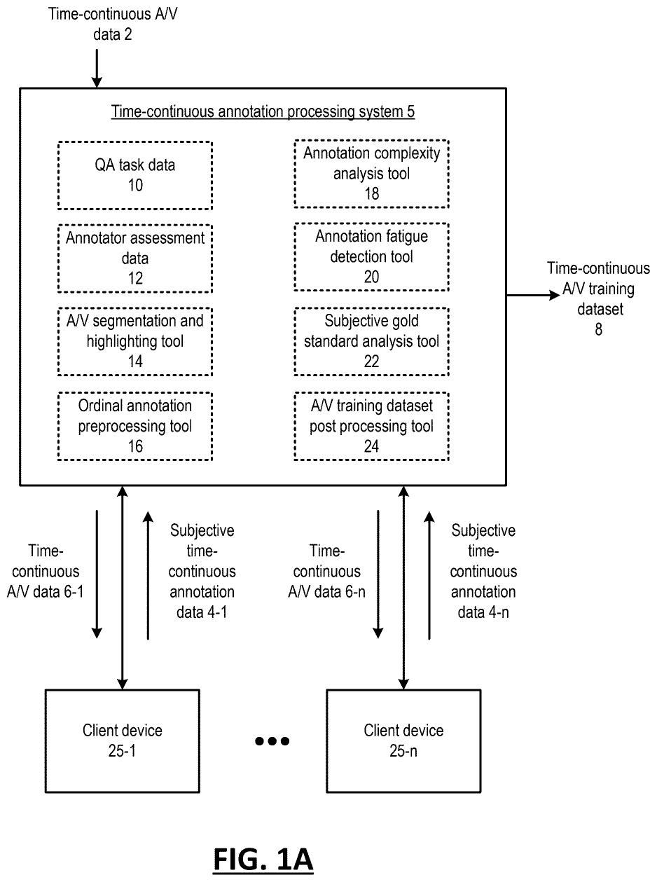

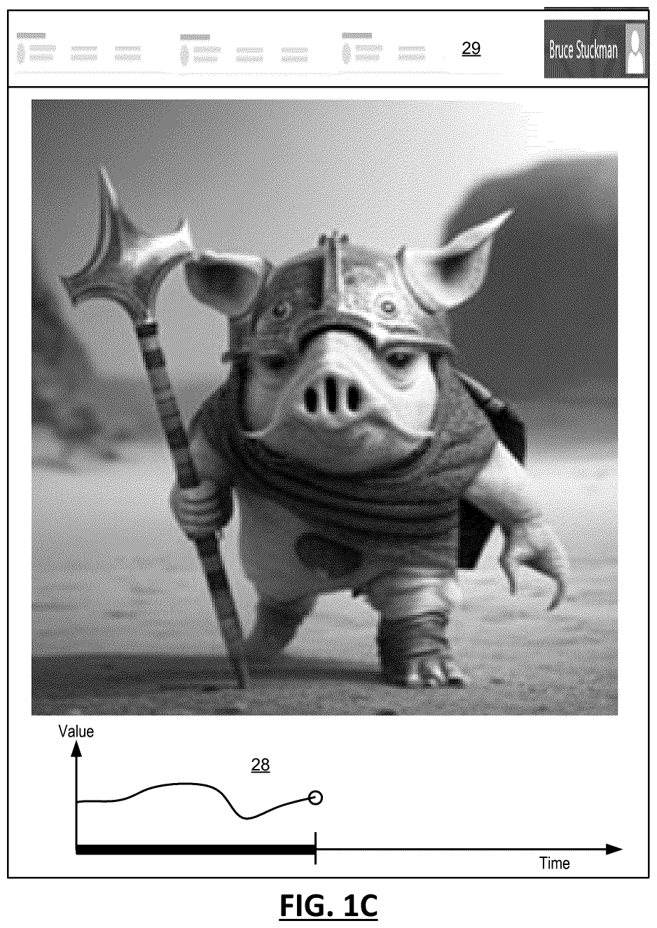

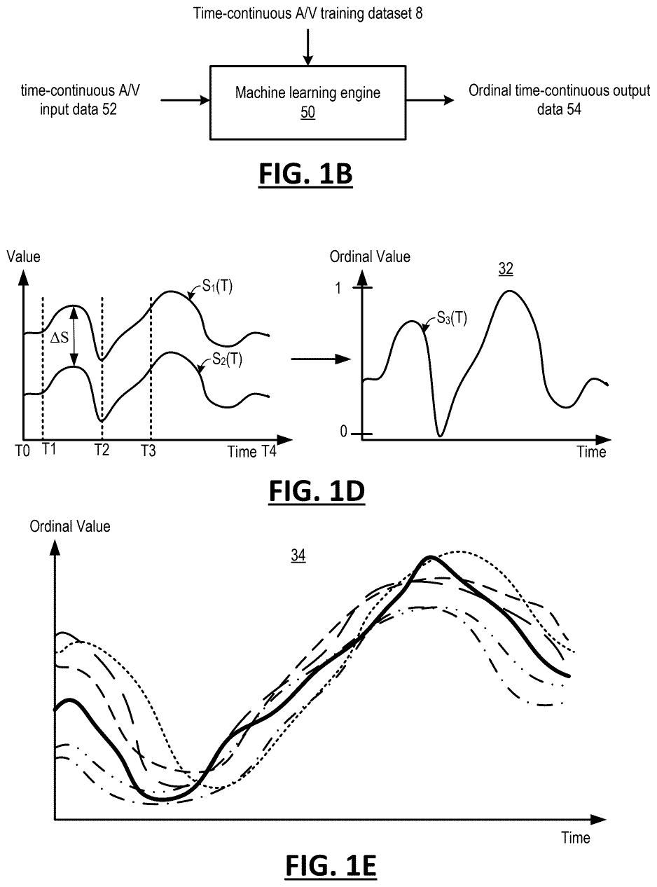

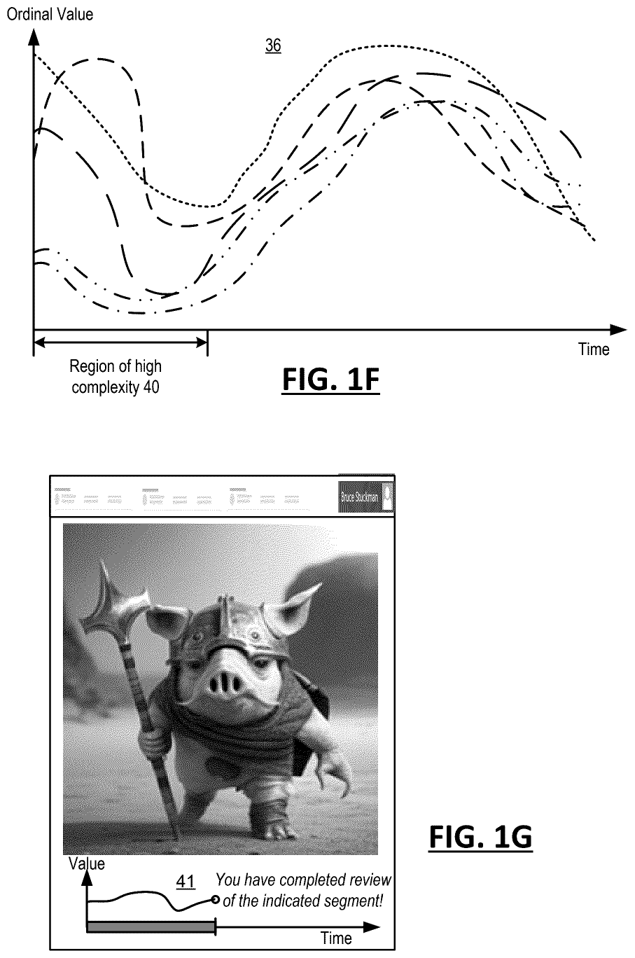

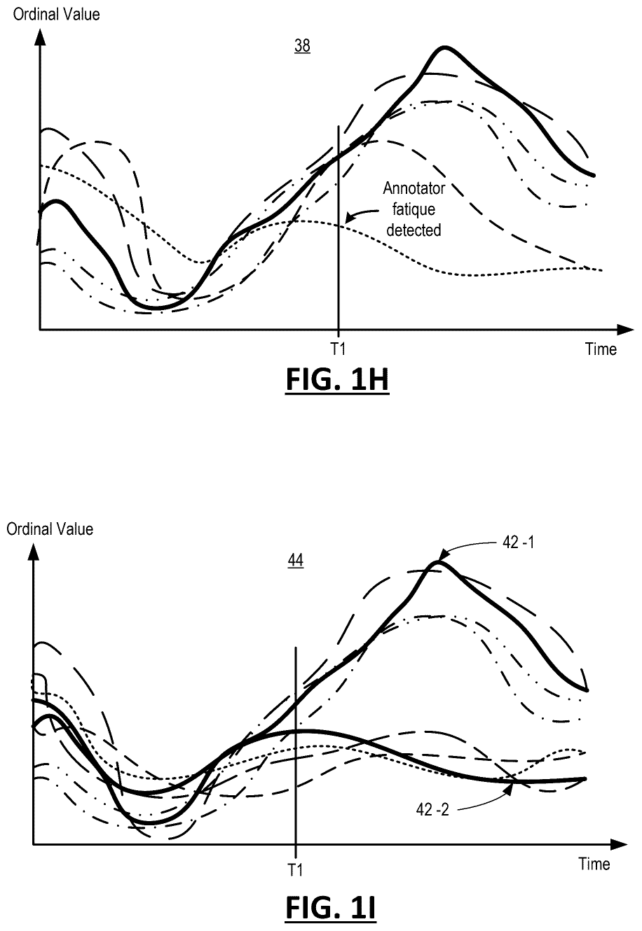

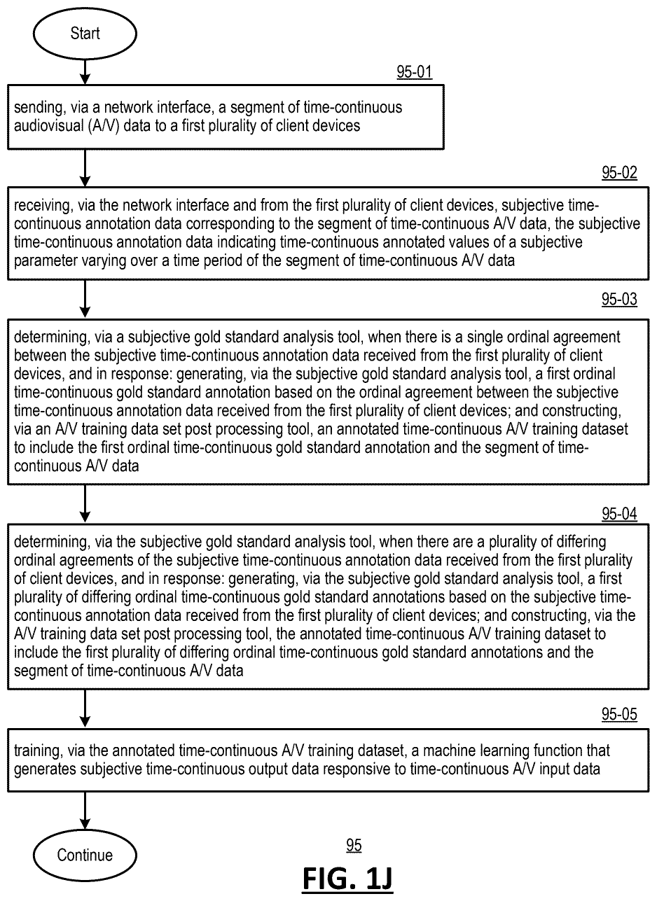

In addition or the alternative to any of the foregoing, further examples of the time-continuous annotation processing system 5, client devices 25 and/or machine learning engine 50, including many optional functions and features, are described in conjunction with FIG. 1B-1J that follow.

FIG. 1B is a schematic block diagram of an example machine learning engine. In the example shown, a time-continuous A/V training dataset 8 is provided to, and used to train, a machine learning engine 50. In various examples, the time-continuous A/V training dataset 8 includes a large number of data pairs, each having one or more ordinal time-continuous gold standard annotations linked to a corresponding segment of time-continuous A/V data 6. Responsive to the training, the machine learning engine 50 can then automatically generate ordinal time-continuous output data 54 when presented time-continuous A/V input data 52.

FIG. 1C is a schematic block diagram of an example screen display. In particular, a screen display 29 of a client device 25-i is presented. In this case, a segment of time-continuous A/V data is presented for display that includes audio and video content from a video game. The user of the client device 25-i is acting as an annotator to create subjective time-continuous annotation data that indicates (in other words “labels”) an ordinal amount of engagement (other subjective index) contemporaneously with the content that is presented. In various examples, the user has interacted with a user interface of the client device 25-i such as a touch screen, mouse, slider bar, touch pad etc, to generate a portion of subjective time-continuous annotation data that includes values up to the current time of the segment being presented—as shown by the graphical representation 28.

FIG. 1D is a graphical example of subjective time-continuous annotation data. In the example shown, subjective time-continuous annotation data S₁(T) and S₂(T) are each differing examples of subjective time-continuous annotation data 4-1 and 4-2 that has been generated based on an annotation of a segment of time-continuous A/V data 6-i. Consider that, for every value of time Ti,

$${S}_{1} ( Ti ) \neq {S}_{2} ( Ti )$$

and more particularly

$${S}_{1} ( Ti ) \neq {S}_{2} ( Ti ) + Δ S$$

Given the non-absolute and ordinal nature of data however, what is important is the relationship between the subjective values at differing times. Note that while each of these sets of data differ, each set shares the same temporal pattern yielding common relationships where, for example,

$${S}_{1} ( T 1 ) > {S}_{1} ( T 2 )$$

$${S}_{1} ( T 3 ) > {S}_{1} ( T 1 )$$

$${S}_{1} ( T 3 ) > {S}_{1} ( T 2 )$$

And similarly,

$${S}_{2} ( T 1 ) > {S}_{2} ( T 2 )$$

$${S}_{2} ( T 3 ) > {S}_{2} ( T 1 )$$

$${S}_{2} ( T 3 ) > {S}_{2} ( T 2 )$$

Given this common temporal pattern, the subjective time-continuous annotation data S₁(T) and S₂(T) can each be preprocessed, via ordinal annotation preprocessing tool 16 to the same ordinal representation S₃(T) without any loss of generality. If various examples, the ordinal annotation preprocessing tool 16 can perform an ordinal transformation to a predetermined range of subjective values, via rank ordering or other non-parametric statistics, strictly monotonic transformations and/or other ordinal transformation operators that are based on the relational nature of the index.

More generally, such an ordinal transformation operator O can be represented by:

$${S}^{′} ( T ) = O [ {S}^{′} ( T ) ]$$

Satisfying the conditions where, for every value of Ti and Tj, for T0<Ti<T4 and T0<Tj<T4,

$$If S ( Ti ) = S ( Tj ) , then {S}^{′} ( Ti ) = {S}^{′} ( Tj )$$

$$If S ( Ti ) > S ( Tj ) , then {S}^{′} ( Ti ) > {S}^{′} ( Tj )$$

$$If S ( Ti ) < S ( Tj ) , then {S}^{′} ( Ti ) < {S}^{′} ( Tj )$$

In various examples, the ordinal annotation preprocessing tool 16 use any such ordinal transformation operator to transform the data sets of subjective time-continuous annotation data 4-1 . . . 4-n to simplify their comparison as well as other processing and analysis performed by the time continuous annotation processing system 5, and enable more standardized comparison of subjective time-continuous annotation data 4-i generated by differing annotators—all while preserving the ordinal/relational nature of the data. Such transformations can further provide greater uniformity when analyzing the sets of subjective time-continuous annotation data 4-1 . . . 4-n generated from differing annotations of the same segment of time-continuous A/V data. It should be noted however, that in other examples the ordinal nature of the subjective time-continuous annotation data 4-1 . . . 4-n generated directly by the client devices 25-1 . . . 25-n could themselves be sufficient for analysis without further transformation or preprocessing. FIG. 1E is a graphical example 34 of subjective time-continuous annotation data. In the example shown, five sets of subjective time-continuous annotation data, corresponding to the same segment of time-continuous A/V data, are presented that indicate ordinal values as a function of time. Each such set is represented by a different pattern of dashes. In this example, the subjective gold standard analysis tool has found (e.g., via clustering) a single ordinal agreement between the subjective time-continuous annotation data, and in response, has generated (e.g., via curve fitting and/or other temporal averaging) a single ordinal time-continuous gold standard annotation that is represented by the bold solid line. In this instance, a linked pair consisting of the segment of time-continuous A/V data 6-i that was annotated along with the ordinal time-continuous gold standard annotation can be added to the time-continuous A/V training data set 8 via a post processing operation.

FIG. 1F is a graphical example 36 of subjective time-continuous annotation data. In the example shown, five sets of subjective time-continuous annotation data, corresponding to the same segment of time-continuous A/V data, are presented that indicate ordinal values as a function of time. Each such set is represented by a different pattern of dashes. In this example, the annotation complexity analysis tool 18 has determined a region of high complexity 40 based on an amount of disagreement (e.g., a lack of sufficient agreement/consensus) that are generated based on ordinal diversity between these temporal annotations. As previously discussed, this determination can be used for several purposes, including highlighting and further segmentation of the corresponding time-continuous A/V data in this region, the number and solicitation of additional annotations and/or the selection of particular experienced annotators to try to resolve the disagreement, and in the detection of annotator fatigue, etc. In the example shown in FIG. 1G, the timeline corresponding to region of high complexity has been highlighted in gray on the timeline graph 41 in the corresponding time-continuous A/V data that has been sent to an additional annotator for review.

FIG. 1H is a graphical example 38 of subjective time-continuous annotation data. In the example shown, five sets of subjective time-continuous annotation data, corresponding to the same segment of time-continuous A/V data, are presented that indicate ordinal values as a function of time. Each such set is represented by a different pattern of dashes. In this example, the annotation fatigue detection tool has detected annotator fatigue in the dashed line that is indicated beginning at a time T1. This detection can be based on an amount of disagreement between the subjective time-continuous annotation data for this annotation and the other four sets of subjective time-continuous annotation data, the number of annotations, total annotation time and/or the degree of annotation complexity associated with a continuous annotation session of this particular annotator. In this case, the subjective time-continuous annotation data for this annotator can de-weighted (e.g., can be ignored or otherwise removed from consideration) either for the entire segment or only for the time period following time T1 when the fatigue was determined to begin. With this data de-weighted, the subjective gold standard analysis tool found a single ordinal agreement between the subjective time-continuous annotation data and generated a single ordinal time-continuous gold standard annotation that is represented by the bold solid line.

FIG. 11 is a graphical example 44 of subjective time-continuous annotation data. In the example shown, six sets of subjective time-continuous annotation data, corresponding to the same segment of time-continuous A/V data, are presented that indicate ordinal values as a function of time. Each such set is represented by a different pattern of dashes. In this example, the subjective gold standard analysis tool has found two different ordinal agreements between the subjective time-continuous annotation data that diverge after time T1. As a result, two ordinal time-continuous gold standard annotations (42-1 and 42-2) are generated that are each represented by bold solid lines. In this instance, a linked set consisting of the segment of time-continuous A/V data 6-i that was annotated along with the two different ordinal time-continuous gold standard annotations can be added to the time-continuous A/V training data set 8 via a post processing operation.

FIG. 1J presents a flowchart representation of an example method. In particular, a method is presented for use with a time-continuous annotation processing system 5, client devices 25, machine learning engine 50 along with any of the functions and features previously described in conjunction with FIG. 1A-1I.

Step 95-01 includes sending, via a network interface, a segment of time-continuous audiovisual (A/V) data to a first plurality of client devices. Step 95-02 includes receiving, via the network interface and from the first plurality of client devices, subjective time-continuous annotation data corresponding to the segment of time-continuous A/V data, the subjective time-continuous annotation data indicating time-continuous annotated values of a subjective parameter varying over a time period of the segment of time-continuous A/V data. Step 95-03 includes determining, via a subjective gold standard analysis tool, when there is an ordinal agreement between the subjective time-continuous annotation data received from the first plurality of client devices, and in response: generating, via the subjective gold standard analysis tool, a first ordinal time-continuous gold standard annotation based on the ordinal agreement between the subjective time-continuous annotation data received from the first plurality of client devices; and constructing, via an A/V training data set post processing tool, an annotated time-continuous A/V training dataset to include the first ordinal time-continuous gold standard annotation and the segment of time-continuous A/V data.

Step 95-04 includes determining, via the subjective gold standard analysis tool, when there are a plurality of differing ordinal agreements of the subjective time-continuous annotation data received from the first plurality of client devices, and in response: generating, via the subjective gold standard analysis tool, a first plurality of differing ordinal time-continuous gold standard annotations based on the subjective time-continuous annotation data received from the first plurality of client devices; and constructing, via the A/V training data set post processing tool, the annotated time-continuous A/V training dataset to include the first plurality of differing ordinal time-continuous gold standard annotations and the segment of time-continuous A/V data. Step 95-05 includes training, via the annotated time-continuous A/V training dataset, a machine learning function that generates subjective time-continuous output data responsive to time-continuous A/V input data.

In addition or the alternative to any of the foregoing, the steps further include:
determining, via a subjective gold standard analysis tool, when there is an ordinal disagreement between the subjective time-continuous annotation data received from the first plurality of client devices for at least a portion of the segment of time-continuous A/V data;
sending, via the network interface, the at least a portion of the segment of time-continuous A/V data to a second plurality of client devices;
receiving, via the network interface and from the second plurality of client devices, subjective time-continuous annotation data corresponding to the at least a portion of the segment of time-continuous A/V data; and
resolving the ordinal disagreement based on the subjective time-continuous annotation data corresponding to the at least a portion of the segment of time-continuous A/V data received from the second plurality of client devices.

In addition or the alternative to any of the foregoing, resolving the ordinal disagreement includes generating, via the subjective gold standard analysis tool, a second plurality of differing ordinal time-continuous gold standard annotations, and wherein the steps further include constructing, via the A/V training data set post processing tool, the annotated time-continuous A/V training dataset to include the second plurality of differing ordinal time-continuous gold standard annotations and the segment of time-continuous A/V data.

In addition or the alternative to any of the foregoing, resolving the ordinal disagreement includes generating, via the subjective gold standard analysis tool, a second ordinal time-continuous gold standard annotation, and wherein the steps further include constructing, via the A/V training data set post processing tool, the annotated time-continuous A/V training dataset to include the second ordinal time-continuous gold standard annotations and the segment of time-continuous A/V data.

In addition or the alternative to any of the foregoing, a number of the second plurality of client devices is determined based on an amount of the disagreement between the subjective time-continuous annotation data received from the first plurality of client devices.

In addition or the alternative to any of the foregoing, the steps further include determining, via an annotation complexity analysis tool, an annotation complexity based on an amount of the disagreement between the subjective time-continuous annotation data received from the first plurality of client devices.

In addition or the alternative to any of the foregoing, the steps further include:
generating an indication, via a segmentation and highlighting tool, of the at least a portion of the segment of time-continuous A/V data; and
sending, via the network interface, the indication in conjunction with the at least a portion of the segment of time-continuous A/V data to the second plurality of client devices.

In addition or the alternative to any of the foregoing, the disagreement between the subjective time-continuous annotation data received from the first plurality of client devices is determined based on a clustering function.

In addition or the alternative to any of the foregoing, the steps further include:
receiving annotator identifiers associated with each of the first plurality of client devices;
determining, via an annotation fatigue detection tool, an annotator fatigue condition associated with one of the first plurality of client devices; and
de-weighting, via the subjective gold standard analysis tool, the subjective time-continuous annotation data received from the one of the first plurality of client devices.

In addition or the alternative to any of the foregoing, the annotator fatigue condition is detected based on an amount of disagreement between the subjective time-continuous annotation data received from the one of the first plurality of client devices and others of the first plurality of client devices.

In addition or the alternative to any of the foregoing, the annotator fatigue condition is detected based on an annotation complexity.

In addition or the alternative to any of the foregoing, the annotator fatigue condition is detected based on a continuous annotation duration associated with the one of the first plurality of client devices.

In addition or the alternative to any of the foregoing, the annotator fatigue condition is detected based on an annotator identifier associated with the one of the first plurality of client devices.

In addition or the alternative to any of the foregoing, the segment of time-continuous A/V data is generated, via an A/V segmentation and highlighting tool, by segmenting time-continuous A/V data.

In addition or the alternative to any of the foregoing, the subjective time-continuous annotation data received from the first plurality of client devices is ordinal preprocessed, via an ordinal annotation preprocessing tool, prior to input to the subjective gold standard analysis tool.

In addition or the alternative to any of the foregoing, the memory further stores a plurality of annotator assessment data and wherein the first plurality of client devices are selected based on the annotator assessment data.

In addition or the alternative to any of the foregoing, the memory further stores a plurality of quality assessment (QA) task data, wherein the plurality of annotator assessment data is determined based on QA annotation data generated by a second plurality of client devices responsive to the QA task data, and wherein the first plurality of client devices is a non-null subset of the second plurality of client devices.

In addition or the alternative to any of the foregoing, the first plurality of client devices are selected based on at least one QA threshold.

In addition or the alternative to any of the foregoing, the subjective gold standard analysis tool determines when there is the single ordinal agreement based on a clustering function identifying a single cluster from the subjective time-continuous annotation data.

In addition or the alternative to any of the foregoing, the subjective gold standard analysis tool determines when there are a plurality of differing ordinal agreements based on the clustering function identifying a plurality of differing clusters from the subjective time-continuous annotation data.

FIGS. 2A through 2E are schematic block diagrams of embodiments of computing entities that form at least part of an improved computer technology. In particular, these computing entities can be used to implement the time-continuous annotation processing system 5, the client devices 25, and/or the machine learning engine 50.

FIG. 2A is schematic block diagram of an embodiment of a computing entity 110 that includes a computing device 120 (e.g., one or more of the embodiments of FIG. 2F-2L). A computing device may function as a user computing device, a server, a system computing device, a data storage device, a data security device, a networking device, a user access device, a cell phone, a tablet, a laptop, a printer, a game console, a satellite control box, a cable box, etc.

FIG. 2B is schematic block diagram of an embodiment of a computing entity 110 that includes two or more computing devices 120 (e.g., two or more from any combination of the embodiments of FIG. 2F-2L). The computing devices 120 perform the functions of a computing entity in a peer processing manner (e.g., coordinate together to perform the functions), in a master-slave manner (e.g., one computing device coordinates and the other supports it), and/or in another manner.

FIG. 2C is schematic block diagram of an embodiment of a computing entity 110 that includes a network of computing devices 120 (e.g., two or more from any combination of the embodiments of FIG. 2F-2L). The computing devices are coupled together via one or more network connections (e.g., WAN, LAN, cellular data, WLAN, etc.) and perform the functions of the computing entity.

FIG. 2D is schematic block diagram of an embodiment of a computing entity 110 that includes a primary computing device (e.g., any one of the computing devices of FIG. 2F-2L), an interface device (e.g., a network connection), and a network of computing devices 120 (e.g., one or more from any combination of the embodiments of FIG. 2F-2L). The primary computing device utilizes the other computing devices as co-processors to execute one or more of the functions of the computing entity, as storage for data, for other data processing functions, and/or storage purposes.

FIG. 2E is schematic block diagram of an embodiment of a computing entity 110 that includes a primary computing device (e.g., any one of the computing devices of FIG. 2F-2L), an interface device (e.g., a network connection) 122, and a network of computing resources 124 (e.g., two or more resources from any combination of the embodiments of FIG. 2F-2L). The primary computing device utilizes the computing resources as co-processors to execute one or more of the functions of the computing entity, as storage for data, for other data processing functions, and/or storage purposes.

FIG. 2F-2L are schematic block diagram of embodiments of computing devices that form at least a portion of a computing entity. FIG. 2F is a schematic block diagram of an embodiment of a computing device 120 that includes a plurality of computing resources. The computing resources, which form a computing core, include one or more core control modules 130, one or more processing modules 132, one or more main memories 136, a read only memory (ROM) 134 for a boot up sequence, cache memory 138, one or more video graphics processing modules 140, one or more displays 142 (optional), an Input-Output (I/O) peripheral control module 144, an I/O interface module 146 (which could be omitted if direct connect IO is implemented), one or more input interface modules 148, one or more output interface modules 150, one or more network interface modules 158, and one or more memory interface modules 156.

A processing module 132 is described in greater detail at the end of the detailed description section and, in an alternative embodiment, has a direction connection to the main memory 136. In an alternate embodiment, the core control module 130 and the I/O and/or peripheral control module 144 are one module, such as a chipset, a quick path interconnect (QPI), and/or an ultra-path interconnect (UPI).

The processing module 132, the core module 130, and/or the video graphics processing module 140 form a processing core for the improved computer. Additional combinations of processing modules 132, core modules 130, and/or video graphics processing modules 140 form co-processors for the improved computer for technology. Computing resources 124 of FIG. 2E include one more of the components shown in this Figure and/or in or more of FIGS. 2G through 2L.

Each of the main memories 136 includes one or more Random Access Memory (RAM) integrated circuits, or chips. In general, the main memory 136 stores data and operational instructions most relevant for the processing module 132. For example, the core control module 130 coordinates the transfer of data and/or operational instructions between the main memory 136 and the secondary memory device(s) 160. The data and/or operational instructions retrieved from secondary memory 160 are the data and/or operational instructions requested by the processing module or will most likely be needed by the processing module. When the processing module is done with the data and/or operational instructions in main memory, the core control module 130 coordinates sending updated data to the secondary memory 160 for storage.

The secondary memory 160 includes one or more hard drives, one or more solid state memory chips, and/or one or more other large capacity storage devices that, in comparison to cache memory and main memory devices, is/are relatively inexpensive with respect to cost per amount of data stored. The secondary memory 160 is coupled to the core control module 130 via the I/O and/or peripheral control module 144 and via one or more memory interface modules 156. In an embodiment, the I/O and/or peripheral control module 144 includes one or more Peripheral Component Interface (PCI) buses to which peripheral components connect to the core control module 130. A memory interface module 156 includes a software driver and a hardware connector for coupling a memory device to the I/O and/or peripheral control module 144. For example, a memory interface 156 is in accordance with a Serial Advanced Technology Attachment (SATA) port.

The core control module 130 coordinates data communications between the processing module(s) 132 and network(s) via the I/O and/or peripheral control module 144, the network interface module(s) 158, and one or more network cards 162. A network card 160 includes a wireless communication unit or a wired communication unit. A wireless communication unit includes a wireless local area network (WLAN) communication device, a cellular communication device, a Bluetooth device, and/or a ZigBee communication device. A wired communication unit includes a Gigabit LAN connection, a Firewire connection, and/or a proprietary computer wired connection. A network interface module 158 includes a software driver and a hardware connector for coupling the network card to the I/O and/or peripheral control module 144. For example, the network interface module 158 is in accordance with one or more versions of IEEE 802.11, cellular telephone protocols, 10/100/1000 Gigabit LAN protocols, etc.

The core control module 130 coordinates data communications between the processing module(s) 132 and input device(s) 152 via the input interface module(s) 148, the I/O interface 146, and the I/O and/or peripheral control module 144. An input device 152 includes a keypad, a keyboard, control switches, a touchpad, a microphone, a camera, etc. An input interface module 148 includes a software driver and a hardware connector for coupling an input device to the I/O and/or peripheral control module 144. In an embodiment, an input interface module 148 is in accordance with one or more Universal Serial Bus (USB) protocols.

The core control module 130 coordinates data communications between the processing module(s) 132 and output device(s) 154 via the output interface module(s) 150 and the I/O and/or peripheral control module 144. An output device 154 includes a speaker, auxiliary memory, headphones, etc. An output interface module 150 includes a software driver and a hardware connector for coupling an output device to the I/O and/or peripheral control module 144. In an embodiment, an output interface module 150 is in accordance with one or more audio codec protocols.

The processing module 132 communicates directly with a video graphics processing module 140 to display data on the display 142. The display 142 includes an LED (light emitting diode) display, an LCD (liquid crystal display), and/or other type of display technology. The display has a resolution, an aspect ratio, and other features that affect the quality of the display. The video graphics processing module 140 receives data from the processing module 132, processes the data to produce rendered data in accordance with the characteristics of the display, and provides the rendered data to the display 142.

FIG. 2G is a schematic block diagram of an embodiment of a computing device 120 that includes a plurality of computing resources similar to the computing resources of FIG. 2F with the addition of one or more cloud memory interface modules 164, one or more cloud processing interface modules 166, cloud memory 168, and one or more cloud processing modules 170. The cloud memory 168 includes one or more tiers of memory (e.g., ROM, volatile (RAM, main, etc.), non-volatile (hard drive, solid-state, etc.) and/or backup (hard drive, tape, etc.)) that is remoted from the core control module and is accessed via a network (WAN and/or LAN). The cloud processing module 170 is similar to processing module 132 but is remote from the core control module and is accessed via a network.

FIG. 2H is a schematic block diagram of an embodiment of a computing device 120 that includes a plurality of computing resources similar to the computing resources of FIG. 2G with a change in how the cloud memory interface module(s) 164 and the cloud processing interface module(s) 166 are coupled to the core control module 130. In this embodiment, the interface modules 164 and 166 are coupled to a cloud peripheral control module 172 that directly couples to the core control module 130.

FIG. 2I is a schematic block diagram of an embodiment of a computing device 120 that includes a plurality of computing resources, which includes include a core control module 130, a boot up processing module 176, boot up RAM 174, a read only memory (ROM) 134, a one or more video graphics processing modules 140, one or more displays 48 (optional), an Input-Output (I/O) peripheral control module 144, one or more input interface modules 148, one or more output interface modules 150, one or more cloud memory interface modules 164, one or more cloud processing interface modules 166, cloud memory 168, and cloud processing module(s) 170.

In this embodiment, the computing device 120 includes enough processing resources (e.g., module 176, ROM 134, and RAM 174) to boot up. Once booted up, the cloud memory 168 and the cloud processing module(s) 170 function as the computing device's memory (e.g., main and hard drive) and processing module.

FIG. 2J is a schematic block diagram of another embodiment of a computing device 120 that includes a hardware section 180 and a software program section 182. The hardware section 180 includes the hardware functions of power management, processing, memory, communications, and input/output. FIG. 2L illustrates the hardware section 180 in greater detail.

The software program section 182 includes an operating system 184, system and/or utilities applications, and user applications. The software program section further includes APIs and HWIs. APIs (application programming interface) are the interfaces between the system and/or utilities applications and the operating system and the interfaces between the user applications and the operating system 184. HWIs (hardware interface) are the interfaces between the hardware components and the operating system. For some hardware components, the HWI is a software driver. The functions of the operating system 184 are discussed in greater detail with reference to FIG. 2K.

FIG. 2K is a diagram of an example of the functions of the operating system of a computing device 120. In general, the operating system function to identify and route input data to the right places within the computer and to identify and route output data to the right places within the computer. Input data is with respect to the processing module and includes data received from the input devices, data retrieved from main memory, data retrieved from secondary memory, and/or data received via a network card. Output data is with respect to the processing module and includes data to be written into main memory, data to be written into secondary memory, data to be displayed via the display and/or an output device, and data to be communicated via a network care.

The operating system 184 includes the OS functions of process management, command interpreter system, I/O device management, main memory management, file management, secondary storage management, error detection & correction management, and security management. The process management OS function manages processes of the software section operating on the hardware section, where a process is a program or portion thereof.

The process management OS function includes a plurality of specific functions to manage the interaction of software and hardware. The specific functions include:
load a process for execution;
enable at least partial execution of a process;
suspend execution of a process;
resume execution of a process;
terminate execution of a process;
load operational instructions and/or data into main memory for a process;
provide communication between two or more active processes;
avoid deadlock of a process and/or interdependent processes; and
control access to shared hardware components.

The I/O Device Management OS function coordinates translation of input data into programming language data and/or into machine language data used by the hardware components and translation of machine language data and/or programming language data into output data. Typically, input devices and/or output devices have an associated driver that provides at least a portion of the data translation. For example, a microphone captures analog audible signals and converts them into digital audio signals per an audio encoding format. An audio input driver converts, if needed, the digital audio signals into a format that is readily usable by a hardware component.

The File Management OS function coordinates the storage and retrieval of data as files in a file directory system, which is stored in memory of the computing device. In general, the file management OS function includes the specific functions of:
File creation, editing, deletion, and/or archiving;
Directory creation, editing, deletion, and/or archiving;
Memory mapping files and/or directors to memory locations of secondary memory; and
Backing up of files and/or directories.

The Network Management OS function manages access to a network by the computing device. Network management includes
Network fault analysis;
Network maintenance for quality of service;
Network access control among multiple clients; and
Network security upkeep.

The Main Memory Management OS function manages access to the main memory of a computing device. This includes keeping track of memory space usage and which processes are using it; allocating available memory space to requesting processes; and deallocating memory space from terminated processes.

The Secondary Storage Management OS function manages access to the secondary memory of a computing device. This includes free memory space management, storage allocation, disk scheduling, and memory defragmentation.

The Security Management OS function protects the computing device from internal and external issues that could adversely affect the operations of the computing device. With respect to internal issues, the OS function ensures that processes negligibly interfere with each other; ensures that processes are accessing the appropriate hardware components, the appropriate files, etc. ; and ensures that processes execute within appropriate memory spaces (e.g., user memory space for user applications, system memory space for system applications, etc.).

The security management OS function also protects the computing device from external issues, such as, but not limited to, hack attempts, phishing attacks, denial of service attacks, bait and switch attacks, cookie theft, a virus, a trojan horse, a worm, click jacking attacks, keylogger attacks, eavesdropping, waterhole attacks, SQL injection attacks, and DNS spoofing attacks.

FIG. 2L is a schematic block diagram of the hardware components of the hardware section 180 of a computing device. The memory portion of the hardware section includes the ROM 134, the main memory 136, the cache memory 138, the cloud memory 168, and the secondary memory 160. The processing portion of the hardware section includes the core control module 130, the processing module 132, the video graphics processing module 140, and the cloud processing module 170.

The input/output portion of the hardware section includes the cloud peripheral control module 172, the I/O and/or peripheral control module 144, the network interface module 158, the I/O interface module 146, the output device interface 150, the input device interface 148, the cloud memory interface module 164, the cloud processing interface module 166, and the secondary memory interface module 156. The IO portion further includes input devices such as a touch screen, a microphone, and switches. The IO portion also includes output devices such as speakers and a display.

The communication portion includes an ethernet transceiver network card (NC), a WLAN network card, a cellular transceiver, a Bluetooth transceiver, and/or any other device for wired and/or wireless network communication.

FIG. 2M is a schematic block diagram of an embodiment of a database that includes a data input computing entity 190, a data organizing computing entity 192, a data query processing computing entity 194, and a data storage computing entity 196. Each of the computing entities is an implementation in accordance with one or more of the embodiments of FIGS. 2A through 2E.

The data input computing entity 190 is operable to receive an input data set 198. The input data set 198 is a collection of related data that can be represented in a tabular form of columns and rows, and/or other tabular structure. In an example, the columns represent different data elements of data for a particular source and the rows corresponds to the different sources (e.g., employees, licenses, email communications, etc.).

If the data set 198 is in a desired tabular format, the data input computing entity 190 provides the data set to the data organizing computing entity 192. If not, the data input computing entity 190 reformats the data set to put it into the desired tabular format.

The data organizing computing entity 192 organizes the data set 198 in accordance with a data organizing input 202. In an example, the input 202 is regarding a particular query and requests that the data be organized for efficient analysis of the data for the query. In another example, the input 202 instructions the data organizing computing entity 192 to organize the data in a time-based manner. The organized data is provided to the data storage computing entity for storage.

When the data query processing computing entity 194 receives a query 200, it accesses the data storage computing entity 196 regarding a data set for the query. If the data set is stored in a desired format for the query, the data query processing computing entity 194 retrieves the data set and executes the query to produce a query response 204. If the data set is not stored in the desired format, the data query processing computing entity 194 communicates with the data organizing computing entity 192, which re-organizes the data set into the desired format.

It is noted that terminologies as may be used herein such as bit stream, stream, signal sequence, etc. (or their equivalents) have been used interchangeably to describe digital information whose content corresponds to any of a number of desired types (e.g., data, video, speech, text, graphics, audio, etc. any of which may generally be referred to as ‘data’). As used herein, audiovisual means audio data—including audio data only, visual data—including visual data only, video and/or time-continuous graphical animations, and/or other time-continuous media content.

As may be used herein, the terms “substantially” and “approximately” provide an industry-accepted tolerance for its corresponding term and/or relativity between items. For some industries, an industry-accepted tolerance is less than one percent and, for other industries, the industry-accepted tolerance is 10 percent or more. Other examples of industry-accepted tolerance range from less than one percent to fifty percent. Industry-accepted tolerances correspond to, but are not limited to, component values, integrated circuit process variations, temperature variations, rise and fall times, thermal noise, dimensions, signaling errors, dropped packets, temperatures, pressures, material compositions, and/or performance metrics. Within an industry, tolerance variances of accepted tolerances may be more or less than a percentage level (e.g., dimension tolerance of less than +/−1%). Some relativity between items may range from a difference of less than a percentage level to a few percent. Other relativity between items may range from a difference of a few percent to magnitude of differences.

As may also be used herein, the term(s) “configured to”, “operably coupled to”, “coupled to”, and/or “coupling” includes direct coupling between items and/or indirect coupling between items via an intervening item (e.g., an item includes, but is not limited to, a component, an element, a circuit, and/or a module) where, for an example of indirect coupling, the intervening item does not modify the information of a signal but may adjust its current level, voltage level, and/or power level. As may further be used herein, inferred coupling (i.e., where one element is coupled to another element by inference) includes direct and indirect coupling between two items in the same manner as “coupled to”.

As may even further be used herein, the term “configured to”, “operable to”, “coupled to”, or “operably coupled to” indicates that an item includes one or more of power connections, input(s), output(s), etc., to perform, when activated, one or more its corresponding functions and may further include inferred coupling to one or more other items. As may still further be used herein, the term “associated with”, includes direct and/or indirect coupling of separate items and/or one item being embedded within another item.

As may be used herein, the term “compares favorably”, indicates that a comparison between two or more items, signals, etc., provides a desired relationship. For example, when the desired relationship is that signal 1 has a greater magnitude than signal 2, a favorable comparison may be achieved when the magnitude of signal 1 is greater than that of signal 2 or when the magnitude of signal 2 is less than that of signal 1. As may be used herein, the term “compares unfavorably”, indicates that a comparison between two or more items, signals, etc., fails to provide the desired relationship.

As may be used herein, one or more claims may include, in a specific form of this generic form, the phrase “at least one of a, b, and c” or of this generic form “at least one of a, b, or c”, with more or less elements than “a”, “b”, and “c”. In either phrasing, the phrases are to be interpreted identically. In particular, “at least one of a, b, and c” is equivalent to “at least one of a, b, or c” and shall mean a, b, and/or c. As an example, it means: “a” only, “b” only, “c” only, “a” and “b”, “a” and “c”, “b” and “c”, and/or “a”, “b”, and “c”.

As may also be used herein, the terms “processing module”, “processing circuit”, “processor”, “processing circuitry”, and/or “processing unit” may be a single processing device or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on hard coding of the circuitry and/or operational instructions. The processing module, module, processing circuit, processing circuitry, and/or processing unit may be, or further include, memory and/or an integrated memory element, which may be a single memory device, a plurality of memory devices, and/or embedded circuitry of another processing module, module, processing circuit, processing circuitry, and/or processing unit. Such a memory device may be a read-only memory, random access memory, volatile memory, non-volatile memory, static memory, dynamic memory, flash memory, cache memory, and/or any device that stores digital information. Note that if the processing module, module, processing circuit, processing circuitry, and/or processing unit includes more than one processing device, the processing devices may be centrally located (e.g., directly coupled together via a wired and/or wireless bus structure) or may be distributedly located (e.g., cloud computing via indirect coupling via a local area network and/or a wide area network). Further note that if the processing module, module, processing circuit, processing circuitry and/or processing unit implements one or more of its functions via a state machine, analog circuitry, digital circuitry, and/or logic circuitry, the memory and/or memory element storing the corresponding operational instructions may be embedded within, or external to, the circuitry comprising the state machine, analog circuitry, digital circuitry, and/or logic circuitry. Still further note that, the memory element may store, and the processing module, module, processing circuit, processing circuitry and/or processing unit executes, hard coded and/or operational instructions corresponding to at least some of the steps and/or functions illustrated in one or more of the Figures. Such a memory device or memory element can be included in an article of manufacture.

One or more embodiments have been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claims.

To the extent used, the flow diagram block boundaries and sequence could have been defined otherwise and still perform the certain significant functionality. Such alternate definitions of both functional building blocks and flow diagram blocks and sequences are thus within the scope and spirit of the claims. One of average skill in the art will also recognize that the functional building blocks, and other illustrative blocks, modules and components herein, can be implemented as illustrated or by discrete components, application specific integrated circuits, processors executing appropriate software and the like or any combination thereof.

In addition, a flow diagram may include a “start” and/or “continue” indication. The “start” and “continue” indications reflect that the steps presented can optionally be incorporated in or otherwise used in conjunction with one or more other routines. In addition, a flow diagram may include an “end” and/or “continue” indication. The “end” and/or “continue” indications reflect that the steps presented can end as described and shown or optionally be incorporated in or otherwise used in conjunction with one or more other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

The one or more embodiments are used herein to illustrate one or more aspects, one or more features, one or more concepts, and/or one or more examples. A physical embodiment of an apparatus, an article of manufacture, a machine, and/or of a process may include one or more of the aspects, features, concepts, examples, etc. described with reference to one or more of the embodiments discussed herein. Further, from figure to figure, the embodiments may incorporate the same or similarly named functions, steps, modules, etc. that may use the same or different reference numbers and, as such, the functions, steps, modules, etc. may be the same or similar functions, steps, modules, etc. or different ones.

Unless specifically stated to the contra, signals to, from, and/or between elements in a figure of any of the figures presented herein may be analog or digital, continuous time or discrete time, and single-ended or differential. For instance, if a signal path is shown as a single-ended path, it also represents a differential signal path. Similarly, if a signal path is shown as a differential path, it also represents a single-ended signal path. While one or more particular architectures are described herein, other architectures can likewise be implemented that use one or more data buses not expressly shown, direct connectivity between elements, and/or indirect coupling between other elements as recognized by one of average skill in the art.

The term “module” is used in the description of one or more of the embodiments. A module implements one or more functions via a device such as a processor or other processing device or other hardware that may include or operate in association with a memory that stores operational instructions. A module may operate independently and/or in conjunction with software and/or firmware. As also used herein, a module may contain one or more sub-modules, each of which may be one or more modules.

As may further be used herein, a computer readable memory includes one or more memory elements. A memory element may be a separate memory device, multiple memory devices, or a set of memory locations within a memory device. Such a memory device may be a read-only memory, random access memory, volatile memory, non-volatile memory, static memory, dynamic memory, flash memory, cache memory, and/or any device that stores digital information. The memory device may be in a form a solid-state memory, a hard drive memory, cloud memory, thumb drive, server memory, computing device memory, and/or other physical medium for storing digital information.

As applicable, one or more functions associated with the methods and/or processes described herein can be implemented via a processing module that operates via the non-human “artificial” intelligence (AI) of a machine. Examples of such AI include machines that operate via anomaly detection techniques, decision trees, association rules, expert systems and other knowledge-based systems, computer vision models, artificial neural networks, convolutional neural networks, support vector machines (SVMs), Bayesian networks, genetic algorithms, feature learning, sparse dictionary learning, preference learning, deep learning and other machine learning techniques that are trained using training data via unsupervised, semi-supervised, supervised and/or reinforcement learning, and/or other AI. The human mind is not equipped to perform such AI techniques, not only due to the complexity of these techniques, but also due to the fact that artificial intelligence, by its very definition-requires “artificial” intelligence—i.e., machine/non-human intelligence.

As applicable, one or more functions associated with the methods and/or processes described herein can be implemented as a large-scale system that is operable to receive, transmit and/or process data on a large-scale. As used herein, a large-scale refers to a large number of data, such as one or more kilobytes, megabytes, gigabytes, terabytes or more of data that are received, transmitted and/or processed. Such receiving, transmitting and/or processing of data cannot practically be performed by the human mind on a large-scale within a reasonable period of time, such as within a second, a millisecond, microsecond, a real-time basis or other high speed required by the machines that generate the data, receive the data, convey the data, store the data and/or use the data.

As applicable, one or more functions associated with the methods and/or processes described herein can require data to be manipulated in different ways within overlapping time spans. The human mind is not equipped to perform such different data manipulations independently, contemporaneously, in parallel, and/or on a coordinated basis within a reasonable period of time, such as within a second, a millisecond, microsecond, a real-time basis or other high speed required by the machines that generate the data, receive the data, convey the data, store the data and/or use the data.

As applicable, one or more functions associated with the methods and/or processes described herein can require separate data elements to be stored in memory along with required links (e.g., with the different data elements effectively linked) to other data stored in other locations in the memory. The human mind is not equipped to store data elements in the human mind with required linkages between separate data elements stored in differing locations.

As applicable, one or more functions associated with the methods and/or processes described herein can be implemented in a system that is operable to electronically receive digital data, including data streams, via a wired or wireless communication network and/or to electronically transmit digital data via a wired or wireless communication network. Such receiving and transmitting cannot practically be performed by the human mind because the human mind is not equipped to electronically transmit or receive digital data streams, let alone to transmit and receive digital data streams via a wired or wireless communication network.

As applicable, one or more functions associated with the methods and/or processes described herein can be implemented in a system that is operable to electronically store digital data in a memory device. Such storage cannot practically be performed by the human mind because the human mind is not equipped to electronically store digital data.

While particular combinations of various functions and features of the one or more embodiments have been expressly described herein, other combinations of these features and functions are likewise possible. The present disclosure is not limited by the particular examples disclosed herein and expressly incorporates these other combinations.

What is claimed is:

1. A time-continuous annotation processing system comprises:
a network interface configured to communicate via a communications network;
a memory configured to store instructions; and
at least one processor configured to execute the instructions, which when executed, cause the at least one processor to perform operations that include:
sending, via the network interface, a segment of time-continuous audiovisual (A/V) data to a first plurality of client devices;
receiving, via the network interface and from the first plurality of client devices, subjective time-continuous annotation data corresponding to the segment of time-continuous A/V data, the subjective time-continuous annotation data indicating time-continuous annotated values of a subjective parameter varying over a time period of the segment of time-continuous A/V data;
determining, via a subjective gold standard analysis tool, when there is a single ordinal agreement between the subjective time-continuous annotation data received from the first plurality of client devices, and in response:
generating, via the subjective gold standard analysis tool, a first ordinal time-continuous gold standard annotation based on the single ordinal agreement between the subjective time-continuous annotation data received from the first plurality of client devices; and
constructing, via an A/V training data set post processing tool, an annotated time-continuous A/V training dataset to include the first ordinal time-continuous gold standard annotation and the segment of time-continuous A/V data, wherein the annotated time-continuous A/V training dataset is stored in the memory with a linkage between the first ordinal time-continuous gold standard annotation and the segment of time-continuous A/V data;
determining, via the subjective gold standard analysis tool, when there are a plurality of differing ordinal agreements of the subjective time-continuous annotation data received from the first plurality of client devices, and in response:
generating, via the subjective gold standard analysis tool, a first plurality of differing ordinal time-continuous gold standard annotations based on the subjective time-continuous annotation data received from the first plurality of client devices; and
constructing, via the A/V training data set post processing tool, the annotated time-continuous A/V training dataset to include the first plurality of differing ordinal time-continuous gold standard annotations and the segment of time-continuous A/V data wherein the annotated time-continuous A/V training dataset is stored in the memory with a linkage between the first plurality of differing ordinal time-continuous gold standard annotations and the segment of time-continuous A/V data; and
wherein the annotated time-continuous A/V training dataset is configured for training a machine learning engine that generates subjective time-continuous output data responsive to time-continuous A/V input data.

2. The time-continuous annotation processing system of claim 1, wherein the operations further include:
determining, via a subjective gold standard analysis tool, when there is an ordinal disagreement between the subjective time-continuous annotation data received from the first plurality of client devices for at least a portion of the segment of time-continuous A/V data;
sending, via the network interface, the at least a portion of the segment of time-continuous A/V data to a second plurality of client devices;
receiving, via the network interface and from the second plurality of client devices, subjective time-continuous annotation data corresponding to the at least a portion of the segment of time-continuous A/V data; and
resolving the ordinal disagreement based on the subjective time-continuous annotation data corresponding to the at least a portion of the segment of time-continuous A/V data received from the second plurality of client devices.

3. The time-continuous annotation processing system of claim 2, wherein resolving the ordinal disagreement includes generating, via the subjective gold standard analysis tool, a second plurality of differing ordinal time-continuous gold standard annotations, and wherein the operations further include constructing, via the A/V training data set post processing tool, the annotated time-continuous A/V training dataset to include the second plurality of differing ordinal time-continuous gold standard annotations and the segment of time-continuous A/V data.

4. The time-continuous annotation processing system of claim 2, wherein resolving the ordinal disagreement includes generating, via the subjective gold standard analysis tool, a second ordinal time-continuous gold standard annotation, and wherein the operations further include constructing, via the A/V training data set post processing tool, the annotated time-continuous A/V training dataset to include the second ordinal time-continuous gold standard annotations and the segment of time-continuous A/V data.

5. The time-continuous annotation processing system of claim 2, wherein a number of the second plurality of client devices is determined based on an amount of the disagreement between the subjective time-continuous annotation data received from the first plurality of client devices.

6. The time-continuous annotation processing system of claim 2, wherein the operations further include:
determining, via an annotation complexity analysis tool, an annotation complexity based on an amount of the disagreement between the subjective time-continuous annotation data received from the first plurality of client devices.

7. The time-continuous annotation processing system of claim 2, wherein the operations further include:
generating an indication, via a segmentation and highlighting tool, of the at least a portion of the segment of time-continuous A/V data; and
sending, via the network interface, the indication in conjunction with the at least a portion of the segment of time-continuous A/V data to the second plurality of client devices.

8. The time-continuous annotation processing system of claim 2, wherein the disagreement between the subjective time-continuous annotation data received from the first plurality of client devices is determined based on a clustering function.

9. The time-continuous annotation processing system of claim 1, wherein the operations further include:
receiving annotator identifiers associated with each of the first plurality of client devices;
determining, via an annotation fatigue detection tool, an annotator fatigue condition associated with one of the first plurality of client devices; and
de-weighting, via the subjective gold standard analysis tool, the subjective time-continuous annotation data received from the one of the first plurality of client devices.

10. The time-continuous annotation processing system of claim 9, wherein the annotator fatigue condition is detected based on an amount of disagreement between the subjective time-continuous annotation data received from the one of the first plurality of client devices and others of the first plurality of client devices.

11. The time-continuous annotation processing system of claim 10, wherein the annotator fatigue condition is detected based on an annotation complexity.

12. The time-continuous annotation processing system of claim 10, wherein the annotator fatigue condition is detected based on a continuous annotation duration associated with the one of the first plurality of client devices.

13. The time-continuous annotation processing system of claim 12, wherein the annotator fatigue condition is detected based on an annotator identifier associated with the one of the first plurality of client devices.

14. The time-continuous annotation processing system of claim 1, wherein the segment of time-continuous A/V data is generated, via an A/V segmentation and highlighting tool, by segmenting time-continuous A/V data.

15. The time-continuous annotation processing system of claim 1, wherein the subjective time-continuous annotation data received from the first plurality of client devices is ordinal preprocessed, via an ordinal annotation preprocessing tool, prior to input to the subjective gold standard analysis tool.

16. The time-continuous annotation processing system of claim 1, wherein the memory further stores a plurality of annotator assessment data and wherein the first plurality of client devices are selected based on the annotator assessment data.

17. The time-continuous annotation processing system of claim 16, wherein the memory further stores a plurality of quality assessment (QA) task data, wherein the plurality of annotator assessment data is determined based on QA annotation data generated by a second plurality of client devices responsive to the QA task data, and wherein the first plurality of client devices is a non-null subset of the second plurality of client devices.

18. The time-continuous annotation processing system of claim 16, wherein the first plurality of client devices are selected based on at least one QA threshold.

19. The time-continuous annotation processing system of claim 1, wherein the subjective gold standard analysis tool determines when there is the single ordinal agreement based on a clustering function identifying a single cluster from the subjective time-continuous annotation data.

20. A method comprising:
sending, via a network interface, a segment of time-continuous audiovisual (A/V) data to a first plurality of client devices;
receiving, via the network interface and from the first plurality of client devices, subjective time-continuous annotation data corresponding to the segment of time-continuous A/V data, the subjective time-continuous annotation data indicating time-continuous annotated values of a subjective parameter varying over a time period of the segment of time-continuous A/V data;
determining, via a subjective gold standard analysis tool, when there is a single ordinal agreement between the subjective time-continuous annotation data received from the first plurality of client devices, and in response:
generating, via the subjective gold standard analysis tool, a first ordinal time-continuous gold standard annotation based on the ordinal agreement between the subjective time-continuous annotation data received from the first plurality of client devices; and
constructing, via an A/V training data set post processing tool, an annotated time-continuous A/V training dataset to include the first ordinal time-continuous gold standard annotation and the segment of time-continuous A/V data;
determining, via the subjective gold standard analysis tool, when there are a plurality of differing ordinal agreements of the subjective time-continuous annotation data received from the first plurality of client devices, and in response:
generating, via the subjective gold standard analysis tool, a first plurality of differing ordinal time-continuous gold standard annotations based on the subjective time-continuous annotation data received from the first plurality of client devices; and
constructing, via the A/V training data set post processing tool, the annotated time-continuous A/V training dataset to include the first plurality of differing ordinal time-continuous gold standard annotations and the segment of time-continuous A/V data; and
training, via the annotated time-continuous A/V training dataset, a machine learning function that generates subjective time-continuous output data responsive to time-continuous A/V input data.
